(19) United States
(12) Patent Application Publication
(10) Pub. No.: US 2025/0207563 A1
(43) Pub. Date: Jun. 26, 2025

(54) SYSTEM AND METHOD FOR UTILISING GEOTHERMAL ENERGY

(71) Applicant: MAN Energy Solutions SE, Augsburg (DE)

(72) Inventors: Bob MISCHO, Zollikerberg (CH); Sebastian KÖHLERT, Zürich (CH); Markus SCHÖNENBERGER, Bremgarten (CH)

(21) Appl. No.: 18/979,053

(22) Filed: Dec. 12, 2024

(30) Foreign Application Priority Data
Dec. 21, 2023 (DE) 10 2023 136 275.5

(51) Int. Cl. F03G 4/00; F03G 4/02; F24T 10/20; F25B 9/00

(52) U.S. Cl. CPC F03G 4/045; F03G 4/02; F03G 4/033; F24T 10/20; F25B 9/008; F25B 2313/002

(57) ABSTRACT

A geothermal energy system, having a carbon dioxide store at a first temperature and density, a retrieving device for retrieving carbon dioxide at a second temperature higher than the first temperature and a second density lower than the first density, a heat pump having a first heat exchanger, a compressor, a second heat exchanger, and an expander or a throttle. The first heat exchanger transmits thermal energy of the carbon dioxide to a process medium of the heat pump. The compressor compresses the process medium downstream of the first heat exchanger. The second heat exchanger transmits thermal energy of the compressed process medium to a consumer, and the expander or the throttle expands the process medium downstream of the second heat exchanger, and an introduction device introduces carbon dioxide downstream of the retrieving device and upstream of the heat pump into the system.

### BACKGROUND OF THE INVENTION

### 1. Field of the Invention

The disclosure relates to a system and to a method for utilising geothermal energy.

### 2. Description of Related Art

EP 2 406 562 B1 discloses a system for utilising geothermal energy. The system for utilising geothermal energy disclosed there includes a storage device which is equipped for storing carbon dioxide, which is present at a first temperature level, in a subterranean reservoir. The system for utilising geothermal energy disclosed there further has a retrieval device, which is equipped to retrieve carbon dioxide, which is present at a second temperature level, from the subterranean reservoir, wherein the second temperature level is higher than the first temperature level. Further, this system for utilising geothermal energy has an expander, a compressor and cooling devices. In the expander, that carbon dioxide, which is retrieved from the reservoir with the help of the retrieval device can be expanded in order to generate mechanical energy from thermal energy, which mechanical energy is converted into electrical energy in a generator. The compressor serves for compressing the carbon dioxide expanded in the expander and for compressing carbon dioxide, which is provided by a carbon dioxide source. The cooling devices serve for cooling the carbon dioxide in order to again store cooled carbon dioxide in the reservoir.

U.S. Pat. Nos. 8,316,955 B2, 8,833,475 B2 and 8,991,510 B2 disclose further prior art regarding systems for utilising geothermal energy.

WO 2021/013 465 A1 discloses a system for converting thermal energy into mechanical energy, which can preferentially be utilised in a geothermal powerplant. The system disclosed there has a pump for delivering a flow medium via an arrangement for converting the flow medium from a liquid into a gaseous state, a turbo machine for converting the thermal energy of the flow medium into mechanical energy, a condenser for condensing the gaseous flow medium into a liquid state and a cooling unit for cooling the liquid flow medium.

### SUMMARY OF THE INVENTION

There is a need for a system and for a method for utilising geothermal energy which, compared with the prior art, make possible an improvement of the efficiency and/or an improved utilisation of the heat.

Starting out from this, one aspect of the present invention is a new type of system and method for utilising geothermal energy.

The system for utilising geothermal energy according to one aspect of the invention comprises a storage device equipped for storing carbon dioxide, which is present in a subterranean reservoir at a first temperature level and a first density level.

The system for utilising geothermal energy according to one aspect of the invention comprises a retrieval device equipped for retrieving carbon dioxide, which is present at a second temperature level and a second density level, from the subterranean reservoir, wherein the second temperature level is higher than the first temperature level and the second density level is lower than the first density level.

The system for utilising geothermal energy according to one aspect of the invention comprises a heat pump with a first heat exchanger, a compressor, a second heat exchanger, and an expander or a throttle, wherein the first heat exchanger of the heat pump is equipped for transmitting thermal energy of the carbon dioxide downstream of the retrieval device and upstream of the storage device to a process medium of the heat pump, wherein the compressor of the heat pump is equipped for compressing the process medium of the heat pump downstream of the first heat exchanger and upstream of the second heat exchanger, wherein the second heat exchanger of the heat pump is equipped for transmitting thermal energy of the process medium of the heat pump to a consumer, and wherein the expander or the throttle of the heat pump is equipped for expanding the process medium of the heat pump downstream of the second heat exchanger and upstream of the first heat exchanger.

The system for utilising geothermal energy according to one aspect of the invention comprises an introduction device which is equipped for introducing carbon dioxide of a carbon dioxide source downstream of the retrieval device and upstream of the heat pump into the system for utilising geothermal energy.

In terms of one aspect of the invention present here, the system for utilising geothermal energy comprises a heat pump. By way of the heat pump, thermal energy of the carbon dioxide extracted from the subterranean reservoir can be effectively transmitted to the process medium of the heat pump. The process medium of the heat pump can be brought to a temperature level which can be utilised by at least one consumer for example as heating energy or as process heat. Further, the efficiency of the geothermal process can be increased, the efficiency of which is dependent on the temperature differential and the density differential of the carbon dioxide between the storage device and the retrieval device.

Preferentially, the system for utilising geothermal energy comprises a turbine which is equipped for expanding the carbon dioxide downstream of the retrieval device and upstream of the introduction device and for converting thermal energy into mechanical energy and/or via a generator driven by the turbine into electrical energy. By incorporating the turbine in the system for utilising geothermal energy, the geothermal energy cannot only be utilised in the region of the heat pump by a consumer for example as heating energy or process heat, but the geothermal energy can also be converted into mechanical energy and/or electrical energy. This also serves for increasing the efficiency and the improved harnessing of geothermal energy.

Preferentially, the system for utilising geothermal energy comprises a separating tank which is equipped for separating liquid out of the carbon dioxide downstream of the retrieval device and upstream of the introduction device. In particular, the separating tank is connected between the retrieval device and the turbine. By way of the separating tank it can be ensured that liquid is separated out of the carbon dioxide which is retrieved from the subterranean reservoir via the retrieval device, in order to in particular deliver exclusively gaseous or supercritical carbon dioxide in the direction of the turbine. This also serves for increasing the efficiency of the system for utilising geothermal energy.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1: is a block diagram of a first system for utilising geothermal; and

FIG. 2: is a block diagram of a system for utilising geothermal energy.

### DETAILED DESCRIPTION OF THE PRESENTLY PREFERRED EMBODIMENTS

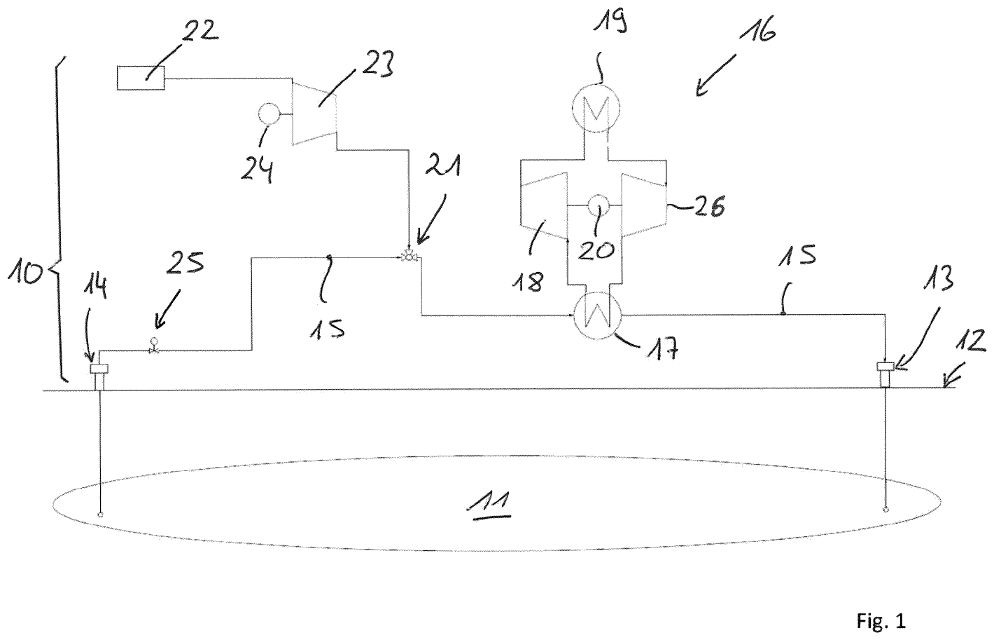

FIG. 1 shows highly schematically a system 10 for utilising geothermal energy together with a subterranean reservoir 11, in which carbon dioxide can be stored and heated by geothermal energy. The subterranean reservoir 11 can be located for example at a depth of one km to five km below the surface of the earth 12.

The system 10 for utilising geothermal energy according to the invention has a storage device 13 which is equipped for storing carbon dioxide which is present at a first temperature level and at a first density level in the subterranean reservoir 11.

Further, the system 10 for utilising geothermal energy has a retrieval device 14 equipped for retrieving carbon dioxide present at a second temperature level and at a second density level from the subterranean reservoir 11. The second temperature level is higher than the first temperature level. The carbon dioxide to be retrieved from the subterranean reservoir 11 via the retrieval device 14 is thus warmer than the carbon dioxide to be stored via the storage device 13 in the subterranean reservoir 11. The second density level is lower than the first density level. Thus, the carbon dioxide to be retrieved in the region of the retrieval device 14 has a lower density than the carbon dioxide to be stored in the subterranean reservoir 11 in the region of the storage device 13.

The carbon dioxide to be retrieved from the subterranean reservoir 11 via the retrieval device 14 can be conducted via a pipeline 15 in the direction of the storage device 13, wherein the system 10 for utilising geothermal energy has a heat pump 16. The heat pump 16 comprises a first heat exchanger 17, a compressor 18, a second heat exchanger 19, and in FIG. 1 an expander 26. Instead of an expander 26, a throttle can also be employed. The first heat exchanger 17 of the heat pump 16 is integrated in the pipeline 15 for the carbon dioxide, wherein the first heat exchanger 17 of the heat pump 16 is equipped for cooling the carbon dioxide downstream of the retrieval device 14 and upstream of the storage device 13 and in the process transmitting thermal energy of the retrieved carbon dioxide to a process medium of the heat pump 16. The compressor 18 of the heat pump 16 is equipped for compressing the process medium of the heat pump 16 heated in the region of the first heat exchanger 17, namely downstream of the first heat exchanger 17 and upstream of the second heat exchanger 19, wherein the second heat exchanger 19 of the heat pump 16 is equipped for transmitting thermal energy of the process medium of the heat pump 16 to a consumer, which can utilised the heat in particular as process heat or thermal heat. In the region of the expander 26, the process medium of the heat pump 16 is expanded in order to be subsequently again provided as expanded process medium to the first heat exchanger 17 of the heat pump 16.

A motor 20 serves for driving the compressor 18 of the heat pump 16. In particular when, as shown in FIG. 1, the heat pump 16 comprises the expander, mechanical energy is gained in the expander 26 during the expansion of the process medium of the heat pump 16, which mechanical energy can be utilised for driving the compressor 18. In this case, the motor 20 can be relieved. When instead of the expander 26 merely a throttle is present, all drive power for driving the compressor 18 of the heat pump 16 has to be provided by the motor 20.

The system 10 for utilising geothermal energy, further, comprises an introduction device 21 which is equipped for introducing carbon dioxide of a carbon dioxide source 22 downstream of the retrieval device 14 and upstream of the heat pump 16 into the system 10 for utilising geothermal energy, namely into the pipeline 15. Between the introduction device 21 and the carbon dioxide source 22 a compressor 23 is connected, which can be driven by a motor 24. By way of the compressor 23, the carbon dioxide of the carbon dioxide source 22 is compressed to a pressure level which corresponds to the pressure level of the carbon dioxide in the region of the pipeline 15 downstream of the retrieval device 14 and upstream of the heat pump 16. Further, FIG. 1 shows a pressure control valve 25, with the help of which the pressure within the pipeline 15 can be directly controlled downstream of the retrieval device 14.

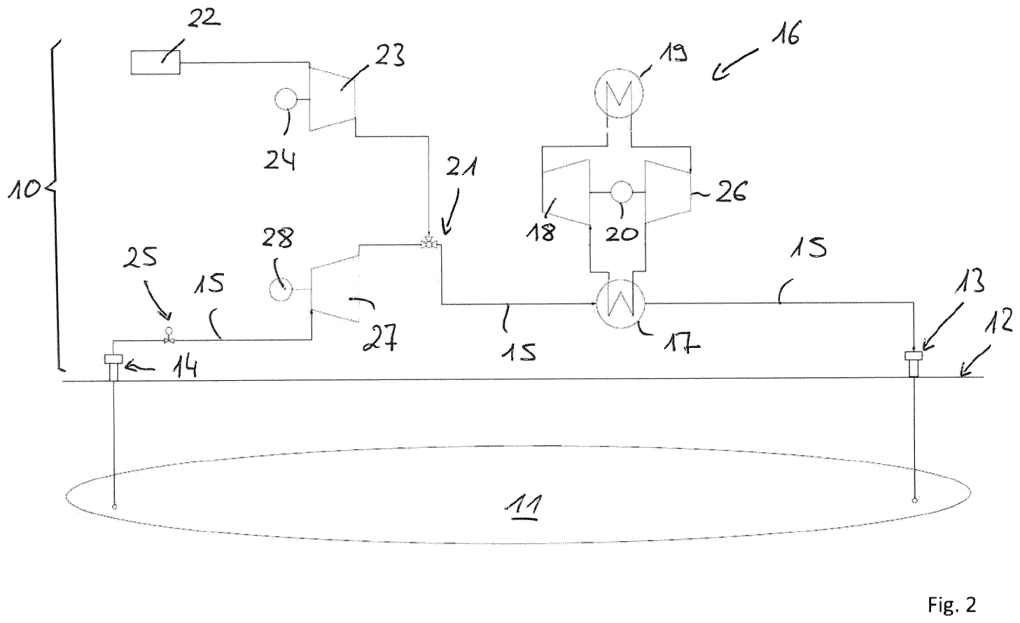

FIG. 2 shows a further development of the system 10 of FIG. 1, wherein for the system 10 for utilising thermal energy of FIG. 2 same reference numbers as in FIG. 1 are used for same assemblies. In the following, only details are discussed in which FIG. 2 differs from FIG. 1. With respect to all remaining details, the exemplary embodiment of FIG. 2 corresponds to the exemplary embodiment of FIG. 1, so that reference can be made to the explanations regarding the exemplary embodiment of FIG. 1.

In FIG. 2, the system 10 for utilising geothermal energy has a turbine 27 equipped for expanding the carbon dioxide downstream of the retrieval device 14 and upstream of the introduction device 21 and thus converting enthalpy of the carbon dioxide into mechanical energy, in order to drive a generator 28 for example, which services for generating electrical energy. The compressor 23 then compresses the carbon dioxide of the carbon dioxide source 22 to a pressure level that is present downstream of the turbine 27.

In FIG. 2, the geothermal energy cannot only be accessible to a consumer in the region of the second heat exchanger 19 of the heat pump 16, but the geothermal energy can also be utilised in the region of the turbine 27 and of the generator 28 for generating mechanical energy and electrical energy. The conversion of the mechanical energy gained in the region of the turbine 27 into electrical energy is preferred, but optional.

It can be provided that the system 10 comprises a separating tank which is not shown in FIG. 1, 2. In the separating tank, liquid can be separated out of the carbon dioxide which was retrieved from the subterranean reservoir 11 via the retrieval device 14. Thus, the efficiency of the system 10 for utilising geothermal energy can be increased. Thus, the reservoir 11 is dried. A mixing of the carbon dioxide flow with water or other liquids, which would reduce the efficiency, can be avoided. Extracting extraneous matter from the carbon dioxide flow thus serves for increasing the efficiency and the full preservation of the function.

The positioning of the separating tank is dependent on the individual components of the system 10. It is mainly dependent on the corrosiveness and the state of aggregation of the extraneous matter in the carbon dioxide flow and the corresponding corrosion resistance of the components and in the case of the turbine 27 on the resistance to liquid components in the substance flow. In the turbine 27, cavitation effects in the case of liquid components in the substance flow could significantly reduce the durability of the turbine 27. This is dependent on the specific design of the turbine 27.

With corresponding incompatibility of individual or multiple components within the system 10, a placement upstream of the corresponding component is preferable. At the same time, separation directly before the storage device 13 and after the turbine 27 and the first heat exchanger 17 increases the efficiency since the enthalpy flow of the extraneous matter in the turbine 27 and/or in the first heat exchanger 17 can be utilised.

Furthermore, the system 10 for utilising geothermal energy can comprise a pump for the carbon dioxide connected between the heat pump 16, namely the first heat exchanger 17 of the same and the storage device 13. Such a pump is optional. Dependent on the pressures of the carbon dioxide in the region of the storage device 13 and the retrieving device 14 and the pressure in the reservoir 11 and the geodetic head, such a pump can be omitted.

Furthermore, the invention relates to a method for operating a system 10 for utilising geothermal energy.

By way of the storage device 13, carbon dioxide, which is present at the first temperature level and the first density level, is stored in the subterranean reservoir 11.

In the region of the retrieving device 14, the carbon dioxide is retrieved from the subterranean reservoir 11 at the second temperature level and the second density level, wherein the carbon dioxide present in the region of the retrieving device 14 can in particular have a supercritical state of aggregation and if applicable partly a gaseous state of aggregation.

By way of the first heat exchanger 17 of the heat pump 16, carbon dioxide is cooled and the density of the carbon dioxide thus increases.

The invention allows an efficient operation and thus an improvement of the efficiency of a system for utilising geothermal energy and an improved harnessing of the geothermal heat.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A system for utilising geothermal energy, comprising:
a storage device configured to store carbon dioxide, which is present at a first temperature level and a first density level, in a subterranean reservoir;
a retrieving device configured to retrieve carbon dioxide, which is present at a second temperature level higher than the first temperature level and a second density level lower than the first density level from the subterranean reservoir;
a heat pump comprising:
a first heat exchanger configured to transmit thermal energy of the carbon dioxide downstream of the retrieving device and upstream of the storage device to a process medium of the heat pump;
a second heat exchanger configured to transmit thermal energy of a process medium of the heat pump to a consumer;
a compressor configured to compress the process medium of the heat pump downstream of the first heat exchanger and upstream of the second heat exchanger; and
an expander or a throttle configured to expand the process medium of the heat pump downstream of the second heat exchanger and upstream of the first heat exchanger; and
an introduction device configured to introduce carbon dioxide of a carbon dioxide source downstream of the retrieving device and upstream of the heat pump into the system for the utilising geothermal energy.

2. The system according to claim 1, further comprising:
a turbine configured to expand the carbon dioxide downstream of the retrieving device and upstream of the introduction device and convert thermal energy into mechanical energy and/or via a generator driven by the turbine, into electrical energy.

3. The system according to claim 2, further comprising:
a separating tank configured to separate liquid out of the carbon dioxide downstream of the retrieving device and upstream of the introduction device.

4. The system according to claim 3,
wherein the separating tank is connected between the retrieving device and the turbine.

5. The system according to claim 1, further comprising:
a pump for the carbon dioxide connected between the heat pump and the storage device.

6. A method for operating a system comprising:
storing by a storage device, gaseous and/or liquid carbon dioxide in a subterranean reservoir;
retrieving by a retrieving device, supercritical carbon dioxide from the subterranean reservoir;
cooling by a first heat exchanger of a heat pump, the supercritical carbon dioxide and/or the gaseous carbon dioxide.
